(19) United States
(12) Patent Application Publication
(10) Pub. No.: US 2011/0128292 A1
(43) Pub. Date: Jun. 2, 2011

(54) DYNAMICS-BASED MOTION GENERATION APPARATUS AND METHOD

(75) Inventors: Sang Won GHYME, Daejeon (KR); Myunggyu KIM, Daejeon (KR); Sung June CHANG, Daejeon (KR); Man Kyu SUNG, Daejeon (KR); Il-Kwon JEONG, Daejeon (KR); Byoung Tae CHOI, Daejeon (KR)

(73) Assignee: Electronics and Telecommunications Research Institute, Daejeon (KR)

(21) Appl. No.: 12/786,009

(22) Filed: May 24, 2010

(30) Foreign Application Priority Data
Dec. 2, 2009 (KR) 10-2009-0118622

(51) Int. Cl. G06T 13/00

(52) U.S. Cl. 345/474

(57) ABSTRACT

A dynamics-based motion generation apparatus includes: a dynamics model conversion unit for automatically converting character model data into dynamics model data of a character to be subjected to a dynamics simulation; a dynamics model control unit for modifying the dynamics model data and adding or modifying an environment model; a dynamics motion conversion unit for automatically converting reference motion data of the character, which has been created by using the character model data, into dynamics motion data through the dynamics simulation by referring to the dynamics model data and the environment model; and a motion editing unit for editing the reference motion data to decrease a gap between reference motion data and dynamics motion data. The apparatus further includes a robot motion control unit for controlling a robot by inputting preset torque values to related joint motors of the robot by referring to the dynamics motion data.

### CROSS-REFERENCE(S) TO RELATED APPLICATION

The present invention claims priority of Korean Patent Application No. 10-2009-0118622, filed on Dec. 2, 2009, which is incorporated herein by reference.

### FIELD OF THE INVENTION

The present invention relates to computer graphics and robot control technology, and, more particularly, to a dynamics-based motion generation apparatus and method which is adapted to provide a user interface capable of creating positions of a three-dimensional (3D) character model having joints corresponding with dynamic constraints and allowing the creation of motions to be easily implemented.

### BACKGROUND OF THE INVENTION

In general, when a motion of a 3D character is created, the 3D character has a skeleton including joints and bones. The motion of a character is generated according to variations in the position of a character skeleton as time lapses. For example, when a 5-second's motion with 30 Hz frame rate is generated, a total of 150 (5*30) motion frames are needed and the pose of a character skeleton are assigned to respective motion frames, thereby configuring the entire motion.

Methods for generating the motion of a 3D character, i.e., assigning pose to respective motion frames are described, as follows.

A first method is configured such that the pose of a character are assigned to all motion frames, respectively. The amount of this work is proportional to a product of the number of joints within a character skeleton, the number of frames per time, and an entire time (nJoints*nFrameRate*nTime). However, since all the work is manually performed, a long period of time is required.

A second method utilizes a 2D animation keyframing technique to set some points of a motion as key frames, assign the positions of a character only to the key frames and automatically create inbetween frames by referring to the previous and subsequent key frames by using an interpolation method. By using this automatic motion creation method, the amount of manual work can be considerably reduced.

The skeleton of a 3D character is generally represented using a tree structure. Lower nodes (joints and bones) are connected to higher nodes, so that the lower nodes are influenced by the movement of the higher nodes. This structure makes the assignment of the positions of a character skeleton difficult.

For example, assume that the motion of a human character moving his arm and holding a cup is created. Although this motion can be simply performed by a real human in such a way as to bring his fingers to the cup, a human character should perform the complicated and sequential tasks of moving an upper arm, moving a lower arm, moving a hand, and then moving fingers even when only an arm is used. A method of assigning motions while moving from a higher node to lower nodes as described above is referred to as forward kinematics motion control. The generation of the motions using this motion control method requires a large amount of work.

Meanwhile, it is possible to automatically assign the motions of higher nodes based on the movement of a lower node, i.e., an end node. This method is referred to as an inverse kinematics motion control. There may be a variety of motions of higher nodes based on the movement of lower nodes. Accordingly, the motion of a character created by inverse kinematics motion control method may be configured such that the end node thereof is placed at a designated in a designated orientation and the locations and orientations of intermediate nodes are not those desired by animator, in which case the locations and orientations of intermediate nodes may be set again by inverse kinematics motion control.

When the forward kinematics motion control method is used, work may be repeatedly performed because the location and orientation of an end node are not accurately predicted. In contrast, when the inverse kinematics motion control method is used, it is possible for an animator to create a desired motion more easily because a motion ranging from the end node to the highest node is assigned at once.

If a character is set to a 3D character which can fly in the sky or raise a building, like Superman, creation of motions of such a character is relatively easy. The reason is that the creation of motions may solely depend on an animator's imagination. Any representation of the motion of a character is free from criticism.

In contrast, if a 3D character represents a human or animal of a real-world, the generation of the motions of such a character is very difficult. The reason is that the motions of a character which act in space which is dominated by physical laws, like the real world, needs to be generated. This means that we who are familiar with the real world can immediately recognize the awkwardness of the motion of a character even when the motion is slightly awkward or exaggerated.

Therefore, it is very difficult to generate the real-world motions of a character using a kinematics motion control method. That is, although it is not difficult to perform imitation similarly, detailed motion cannot be achieved only by the imagination without considering dynamics.

The use of dynamics motion control is very useful to represent motions in the real world. However, it is difficult to use a dynamics motion control method on the basis of only the skeleton of an existing character including the joints and bones. To use a dynamics motion control method, volume, mass and inertia required to be assigned to the bones of an object as in the real world. Additionally, various physical values, such as Gravity and friction force, required to be assigned.

Such values act as constraints on the motion. Although an object can generally be moved freely with six degrees of freedom, the constrained object cannot be moved freely because of other forces (affects on it continuously). Therefore, it is difficult to perform intuitive motion control using the dynamics method.

Animators desire bones to move only in a specific manner, such as in the manner of walking or running. That is, they desire each of the bones to be placed at a specific location in a specific orientation at a specific point of time. Meanwhile, since a skeleton is configured such that bones are connected to each other in a complicated manner and influence each other during motion, it is not easy to calculate the force required for each of the bones to move to a specific location in a specific orientation.

The forward dynamics motion control method gets the time-driven pose of an object from given forces. Reversely, the inverse dynamics method calculates required time-driven forces automatically from given pose of an object.

The currently introduced inverse dynamics motion control methods include a method of calculating approximate force by using a Proportional-Derivative (PD) controller and a method of calculating accurate force required by desired constraints (e.g., a location and an orientation) by using constrained equations.

Here, the method using a PD controller is a simple method of calculating a desired force value by appropriately adjusting constant values K1 and K2 in Equation F=K1 (subsequent location−current location)+K2 (subsequent velocity−current velocity). The paper “Dynamo: Dynamic, Data-driven Character Control with Adjustable Balance” published in 2006 by Pawel Wrotek discloses that a motion similar to the motion of motion capture data is created by using a PD controller. The method using a PD controller is less practical, because it is difficult to find the appropriate constant values K1 and K2 of each bone for a case of a multi-bone character. The method using the constrained equation is also less practical, because it requires large amounts of time and memory space to calculate an accurate force value, but it does not require any other constant values. The dynamics motion control method is not familiar with animators from complexity. The kinematics motion control method requires only the skeleton of character, and a rigged skin model is just optional. But, the dynamics motion control method requires skeleton, volume of character and even environmental information (gravity, friction and the like). The preparation for it is very complex and hard to handle. Animators have to give appropriate physical values (mass, inertia, and the like) and geometric volume to all bone. Such a process is too sensitive that it can easily lead unwanted result. If there is no easy preparation, animators does not have an interest of the dynamics motion control method.

The animation tools which are currently being used by animators to create the motions of characters support all of the above-described motion control methods. A combination of the keyframing motion generation method and the kinematics motion control method is chiefly used. Further, the forward dynamics motion control method is limitedly applied to the free movement of objects based on the collision between the objects, ragdoll motion and the like.

However, the inverse dynamics motion control method is not supported by commercial animation tools, but only research results regarding the method are being published in papers.

### SUMMARY OF THE INVENTION

In view of the above, the present invention provides a dynamics-based motion generation apparatus and method capable of guaranteeing natural motions in compliance with physical laws while maintaining the general form of a motion created by an existing method, by using a dynamics motion control method.

The present invention provides a dynamics-based motion generation apparatus and method capable of correcting motion data created by an animator to objective motion data in compliance with the physical laws through a dynamics simulation, and capable of allowing a beginner to easily generate the motions of a robot using an existing character animation tool and a dynamics-based motion generation system.

In accordance with an aspect of the present invention, there is provided dynamics-based motion generation apparatus.

The apparatus includes: a dynamics model conversion unit for automatically converting character model data input to a computing device into dynamics model data of a character to be subjected to a dynamics simulation; a dynamics model control unit for modifying the dynamics model data and adding or modifying an environment model; a dynamics motion conversion unit for automatically converting motion data of the character, which has been created by using the character model data, into dynamics motion data through the dynamics simulation by referring to the dynamics model data and the environment model; a motion editing unit for editing the dynamics motion data and the motion data of the character; and a robot motion control unit for controlling a robot by inputting preset torque values to related joint motors of the robot by referring to the dynamics motion data.

In accordance with another aspect of the present invention, there is provided a dynamics-based motion generation method.

The method includes: automatically converting character model data input to a computing device into dynamics model data of a character to be subjected to a dynamics simulation; modifying the dynamics model data, and adding or modifying an environment model; automatically converting motion data of the character which has been created by using the character model data into dynamics motion data through the dynamics simulation by referring to the dynamics model data and the environment model; editing the dynamics motion data and the motion data of the character; and controlling a robot by inputting preset torque values to related joint motors of the robot by referring to the dynamics motion data.

### BRIEF DESCRIPTION OF THE DRAWINGS

The objects and features of the present invention will become apparent from the following description of preferred embodiments given in conjunction with the accompanying drawings, in which:

FIG. 1 is a block diagram showing the structure of a dynamics-based motion generation apparatus 100 according to an embodiment of the present invention;

FIG. 2 is a flowchart showing the operation of a dynamics-based motion generation apparatus according to an embodiment of the present invention;

FIG. 3 is a diagram showing the dynamics model data of a horse character created by the dynamics model conversion module of the dynamics-based motion generation apparatus according to an embodiment of the present invention; and

FIG. 4 is a diagram showing the dynamics motion data of the horse character created by the dynamics motion conversion module of the dynamics-based motion generation apparatus and reference motion data according to an embodiment of the present invention.

### DETAILED DESCRIPTION OF THE EMBODIMENTS

Hereinafter, dynamics-based motion generation apparatus and method in accordance with the embodiment of the present invention will be explained in detail with reference to the accompanying drawings which form a part hereof.

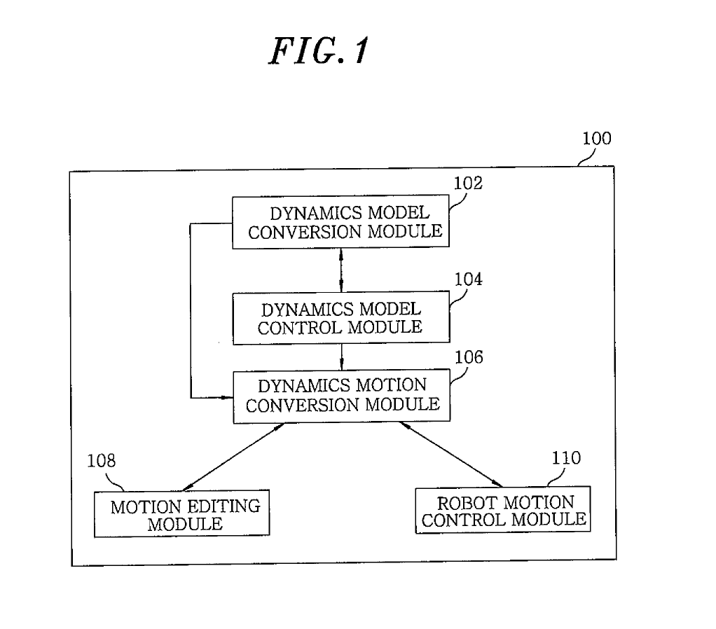

FIG. 1 is a block diagram showing a configuration of a dynamics-based motion generation apparatus 100 in accordance with the embodiment of the present invention.

Referring to FIG. 1, the dynamics-based motion generation apparatus 100 is provided on a computing device such as a computer, a notebook or a mobile phone to be used. The dynamics-based motion generation apparatus includes a dynamics model conversion module 102, a dynamics model control module 104, a dynamics motion conversion module 106, a motion editing module 108, and a robot motion control module 110.

In detail, the dynamics model conversion module 102 automatically converts model data including at least one of existing character skeleton data, skin mesh data and rigging data into the dynamics model data of the character which can be subjected to a dynamics simulation.

Here, the resulting character dynamics model data includes dynamics bone data and dynamics joint data. Further, dynamics bone data includes at least one of a location, orientation, size, mass, inertia, density, mesh, and connected dynamics joint list data. Meanwhile, dynamics joint data includes at least one of a location, type (hinge, universal, or spherical), movement limitation range, maximum torque, and connected dynamics bone list.

The dynamics model control module 104 functions to modify the dynamics model data of the character and to add new environment model data or modify existing environment model data.

The dynamics motion conversion module 106 automatically converts the received existing motion data of a character into dynamics motion data through a dynamics simulation by referring to the dynamics model data of the character or environment model data modified or added by the dynamics model control module 104. That is, the dynamics motion conversion module 106 automatically converts the previously created motion data of a character into dynamics motion data based on dynamics motion control data (dynamics model data). Here, the resulting dynamics motion data may include at least one of input force, input torque, resulting location, resulting orientation, resulting linear velocity, resulting angular velocity and a collision-related event, with respect to each frame of dynamics bones.

The motion editing module 108 synthesizes the motion data of an existing character with the dynamics motion data newly created by the dynamics motion conversion module 106 or edits them, transmits the motion data of a character to the dynamics motion conversion module 106, and provides dynamics motion data to the robot motion control module 110.

The robot motion control module 110 controls a robot by inputting appropriate torque values, i.e., preset experimental torque values, to respective associated joint motors of the robot by referring to the dynamics motion data newly created by the dynamics motion conversion module 106.

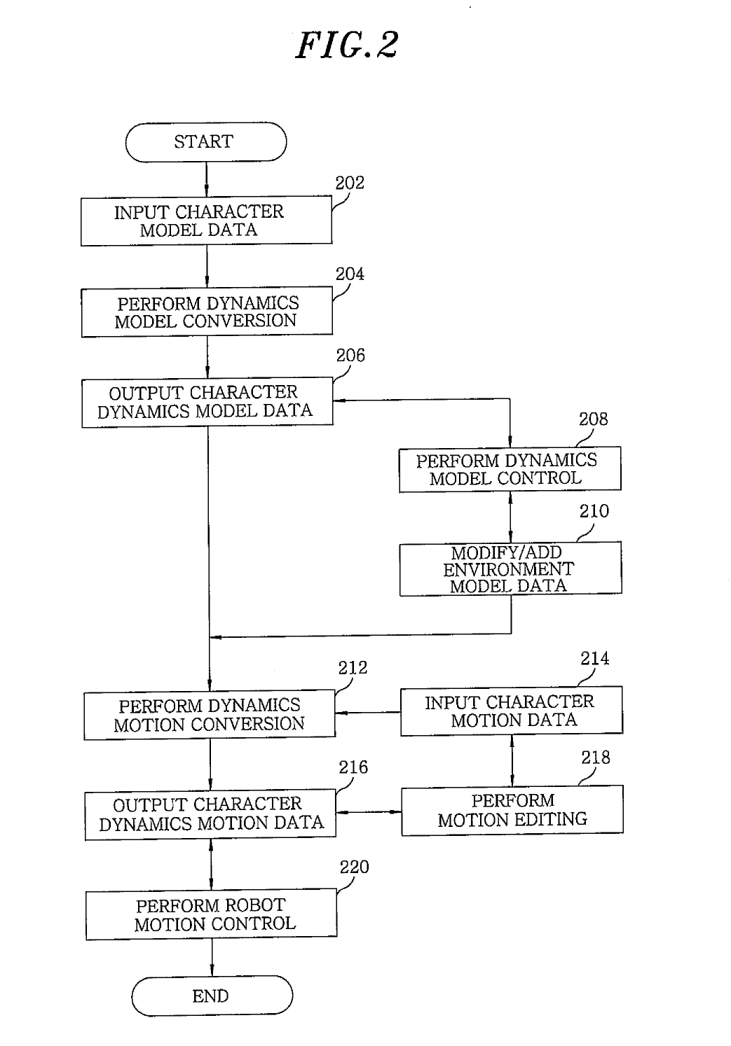

FIG. 2 is a flowchart showing an operation of a dynamics-based motion generation apparatus in accordance with the embodiment of the present invention.

Referring to FIG. 2, at step 202, the dynamics-based motion generation apparatus 100 generates character model data and inputs the character model data to the dynamics model conversion module 102. That is, the apparatus 100 generates skeleton data about the joints and bones of a target character, skin mesh data about the skin of the character covering a skeleton, and rigging data connecting the skin mesh with the skeleton to enable the skin mesh to transform in conjunction with movements of the bones or joint.

The motion data of a character is generated using character model data including the skeleton, skin mesh and rigging data of the character, which are generated as described above. The motion data of a character may be created using keyframing or a kinematics motion control method.

The dynamics model conversion module 102 receives such character model data at step 204, and converts the character model data into character dynamics model data for a dynamics simulation and outputs the character dynamics model data at step 206. Character dynamics model data includes dynamics bone data about bones and dynamics joint data about joints in skeleton data.

The locations, orientations and sizes of dynamics bones can be automatically calculated by consulting the skeleton, skin mesh and rigging data of a character. If there is no skin mesh and/or rigging data, automatic calculation is performed by giving basic thickness information. Automatically calculated data can be manually corrected. In general, though the locations and orientations of the bones of a skeleton may be those of dynamics bones, this is not necessarily true.

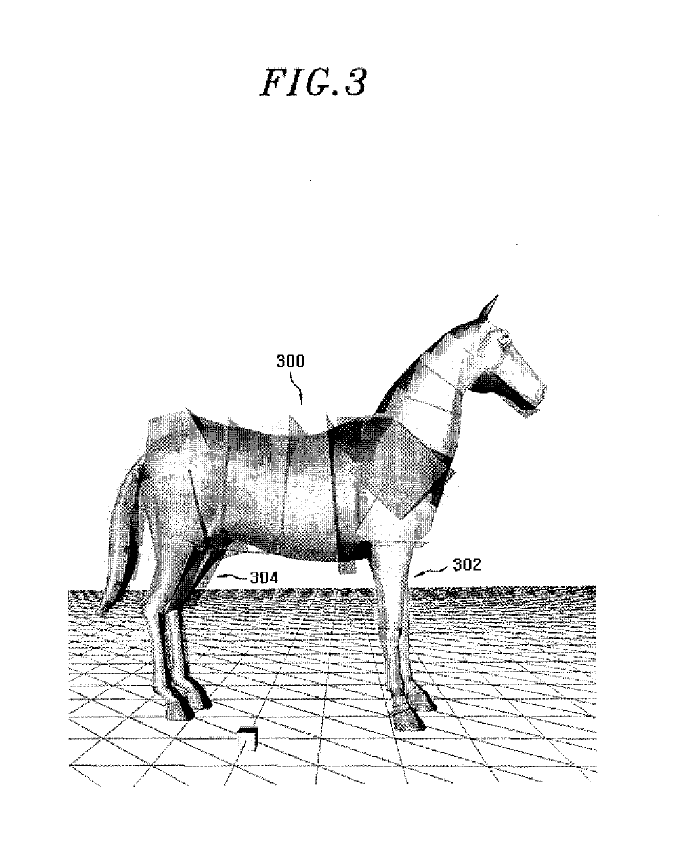

FIG. 3 is a diagram showing the dynamics model data of a horse character generated by the dynamics model conversion module of the dynamics-based motion generation apparatus in accordance with the embodiment of the present invention.

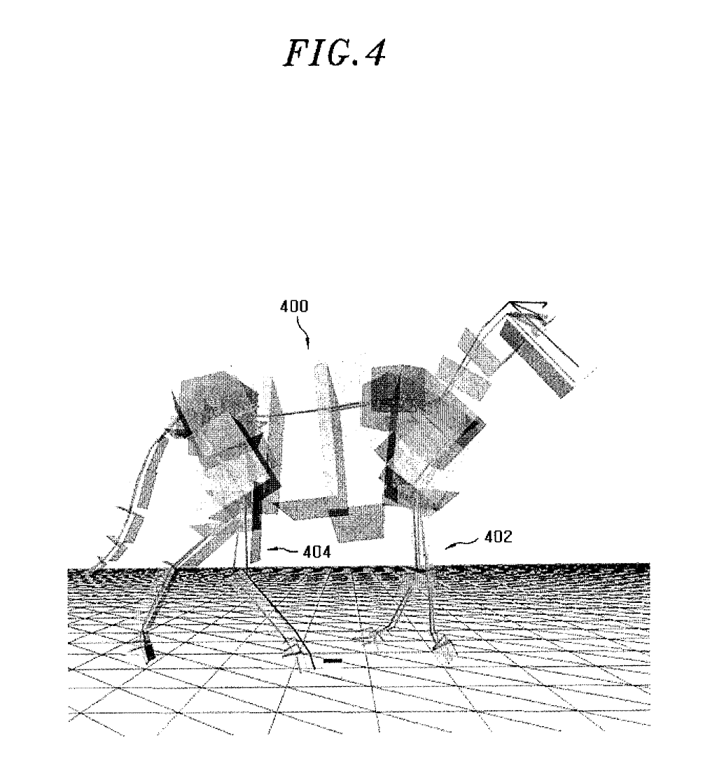

FIG. 4 is a diagram showing the dynamics motion data of the horse character generated by the dynamics motion conversion module of the dynamics-based motion generation apparatus and reference motion data.

Referring to FIGS. 3 and 4, the lower leg 304 or 404 or lower arm 302 or 402 of a horse character is located at the center of a mesh in which bones are connected to each other, so that the location of the bone is almost the same as that of a dynamics bone. However, from the spine 300 or 400 connected to the abdomen, it can be seen that the location of the bone of the spine becomes different from that of a dynamics bone including the abdomen because the abdomen droops low. The mass of a dynamics bone is set to a value obtained by multiplying the ratio of the size of the corresponding bone to the size of the entire character by an appropriately set value.

The inertia of a dynamics bone can be automatically calculated from the skin mesh and rigging data. The density of a dynamics bone is adjusted to have a higher value when a corresponding portion includes lots of dense tissue such as bone and to have a lower value when a corresponding portion includes only flesh.

In the case of a horse character as shown in FIG. 3, the high density of the head or low arm is recommended, while the low density of the spine connected to the abdomen is recommended. The volume mesh of a dynamics bone is used to process collision with another bone or an object. As a volume mesh model, the corresponding skin mesh is better for more accurate collision detection, but it is worse because it takes huge calculation time. Normally, it is recommended that a simple box or cylinder shape model is assigned thereto. In FIG. 3, in the case of the horse character model, boxes are assigned to all meshes for collision processing calculation.

Further, the location of a dynamics joint is made identical to that of the joint of a skeleton. The type of dynamics joint is set according to the degree of freedom of the joint. The maximum torque of a dynamics joint is set to the upper limit of the possible maximum torque value. This may be basically calculated by referring to size data of dynamics bones connected to the dynamics joint.

In a case of a human character, a size of an upper leg and a lower leg connected to a knee joint is large and a size of finger bones connected to a finger joint is small. Therefore, it is better that the maximum torque value of the knee joint is set to greater than that of the finger joint. For the convenience of the animator, all the data of a dynamics model obtained by the dynamics model conversion module 102 may be automatically calculated and assigned.

Meanwhile, the dynamics model control module 104 manually modifies the detailed data of the dynamics model obtained by the dynamics model conversion module 102 at step 208, and newly creates or modifies an environment model at step 210. It is possible to adjust the entire mass of a dynamics bone or the entire maximum torque of a dynamics joint. For example, if an entire mass of a horse model is adjusted from 100 Kg to 500 Kg, a mass of each dynamics bone may be increased five times.

A higher instantaneous torque value can be made as a maximum torque value of a dynamics joint is set higher. With the highly set instantaneous torque value enables dynamics motion data almost identical to the reference motion data received at step 214. When the maximum torque of a dynamics joint is set to a lower value, an instantaneous torque value is decreased, so that the dynamics motion of the character may not properly follow up the motion data. The effect of the low torque can be shown from motion comparison between healthy and unhealthy human action.

It can be said that the generation of more realistic dynamics motions mainly depends on an amount of the maximum torque values of dynamics joints. Although it is not easy to determine the appropriate maximum torque of each dynamics joint, it can be possible to obtain a maximum torque value which allows similar follow-up when motion capture motion data is converted into dynamics motion data.

However, only the normal maximum torque value is not always useful. In a case of Superman, the maximum torque value may be set to a value several times greater than a typical value. By a jump motion, a general human model may jump 1 m high, while Superman may jump 10 m high.

All objects do motion by interaction with environment (ground or other objects) else in where free fall situation. Both human and horse characters perform motions in a process of receiving repulsive force and giving force while walking on the ground or colliding with another character. An appropriate environment model in which forces can be exchanged to achieve the dynamics motion of a character is required.

Therefore, at step 210, the dynamics model control module 104 creates an environment model, such as a ground, a slope or stairs, and adjusts the size, location or orientation of the environment model.

The dynamics motion conversion module 106 performs dynamics simulation by using reference motion data received at step 214, the dynamics model data output from the dynamics model conversion module 102 or modified by the dynamics model control module 104, and the environment model data at step 212. Then, the reference motion data of the character is converted into dynamics motion data and is output at step 216.

Meanwhile, if it is necessary to modify the resulting dynamics motion data, the dynamics model control module 104 modifies the maximum torque of the dynamics joint of the dynamics joint data, inputs the modified maximum torque to the dynamics motion conversion module 106, performs dynamics simulation again, and outputs data converted into dynamics motion data. Here, a dynamics simulator receives a variety of types of constraints such as gravity and frictional force.

Meanwhile, constraints regarding the location, velocity, acceleration of each dynamics bone of a dynamics model are determined depending on the location, velocity and acceleration of each bone set in the motion data of the character. The torque value of each dynamics bone satisfying all constraints could be calculated by solving dynamics equations in an analytic or recursive manner, and results obtained using a torque value controlled to be equal to or lower than a set maximum torque value are recorded in the form of dynamics motion data. Here, the dynamics motion data may include the input force, input torque, resulting location, resulting orientation, resulting linear velocity, resulting angular velocity and collision-related event data of each dynamics bone.

Thereafter, the motion editing module 108 receives the reference motion data and the dynamics motion data of the character, compares both data, edits reference motion data, and outputs the modified reference motion data at step 218.

At step 220, the robot motion control module 110 receives the prepared dynamics motion data of the character, adjusts it, and outputs torque values to be assigned to respective motors of respective joints of a robot to control the same.

The above-described procedure will be described below using an example. When a robot is ready in the present real world, character model data is created by analyzing the shape of the robot, and the created character model data is converted into dynamics model data by the dynamics model conversion module 102.

The motion data of the character is created by referring to the character model data. The motions of a robot character can be easily generated using an existing animation tool. Thereafter, the dynamics motion conversion module 106 creates the dynamics motion data of the robot character by using the dynamics model data and the created motion data of the robot character.

Although the dynamics motion data includes a torque value to be applied to a dynamics joint, this value cannot be applied directly to a robot. Accordingly, the robot motion control module 110 receives a torque value which a dynamics joint has in the dynamics motion data, and outputs a torque value obtained by multiplying the former torque value by a compensation value to the corresponding joint motor of the robot. Since the compensation value of each dynamics joint varies depending on the motor used for the robot, a value can be obtained using experiments.

As described above, the dynamics-based motion generation apparatus and method in accordance with the embodiment of the present invention guarantee natural motions in compliance with physical laws while maintaining the general forms of motions created by an existing method, by using the dynamics motion control method. Further, the present invention proposes a scheme for modifying motion data, created by an animator, into motion data satisfying object physical laws by adopting dynamics simulation.

Meanwhile, the dynamics-based motion generation apparatus and method in accordance with the present invention may be implemented in a computer program. The codes and code segments forming the computer program can be easily implemented by a computer programmer in the corresponding field. Further, the computer program implements the dynamics-based motion generation method in such a way that the program is stored in a computer-readable information storage medium and read and executed by a computer. The information storage medium includes a magnetic storage medium, an optical storage medium, and a carrier wave medium.

The dynamics-based motion generation apparatus and method in accordance with the embodiments of the present invention have one or more of the following advantages.

The dynamics-based motion generation apparatus and method according to the embodiments of the present invention enables the motions of a character, created by an animator using an existing character animation tool, to be automatically created as dynamically modified motions using a dynamics simulation, since it is difficult for an animator to precisely represent the motions of a character in compliance with physical laws in the present real world using an existing character animation tool.

Furthermore, the current representation of robot motions experiences many difficulties because it is difficult to control the joints of a robot, whereas even a beginner can easily represent the motions of a robot using an existing character animation tool and the dynamics-based motion generation system.

The above-described dynamics-based motion generation technique can be implemented in the form of an independent software application or in the form of a plug-in for an existing character animation authoring tool.

While the invention has been shown and described with respect to the preferred embodiments, it will be understood by those skilled in the art that various changes and modifications may be made without departing from the spirit and scope of the invention as defined in the following claims.

What is claimed is:

1. A dynamics-based motion generation apparatus, comprising:
a dynamics model conversion unit for automatically character model data input to a computing device into dynamics model data of a character to be subjected to a dynamics simulation;
a dynamics model control unit for modifying the dynamics model data and adding or modifying an environment model;
a dynamics motion conversion unit for automatically converting reference motion data of the character, which has been created by using the character model data, into dynamics motion data through the dynamics simulation by referring to the dynamics model data and the environment model;
a motion editing unit for editing the reference motion data to decrease a gap between reference motion data and dynamics motion data; and
a robot motion control unit for controlling a robot by inputting preset torque values to related joint motors of the robot by referring to the dynamics motion data.

2. The apparatus of claim 1, wherein the dynamics motion conversion unit:
adds constraints regarding a location, velocity and acceleration of each bone to be corresponded with the motion data of the character; and
converts the dynamics model data into the dynamics motion data through the dynamics simulation which adds constraints satisfying a movement limitation range to dynamics joint data of the dynamics model data and which adds a constraint regarding maximum torque to dynamics bone data of the dynamics model data.

3. The apparatus of claim 2, wherein the dynamics joint data includes at least one data of a location, a joint type, a movement limitation range, a maximum torque, and a list of connected dynamics bones.

4. The apparatus of claim 2, wherein the dynamics bone data includes at least one of a location, an orientation, a size, a mass, inertia, density, mesh, and a list of connected dynamics joints.

5. The apparatus of claim 4, wherein:
the mass is set to a value obtained by multiplying a ratio of a size of the corresponding bone to a size of an entire character to by a preset constant value;
the inertia is calculated from skin mesh and rigging data of the character model data; and
the mesh is processed as a box or cylinder shape.

6. The apparatus of claim 1, wherein the dynamics model control unit controls an extent of conversion of the dynamics motion by controlling a maximum torque value of dynamics joint data of the dynamics model data.

7. The apparatus of claim 1, wherein the dynamics model control unit creates the environment model based on a motion environment of the character, modifies at least one of a size, location and orientation of the created environment model, and transmits modification results to the dynamics motion conversion unit.

8. The apparatus of claim 1, wherein the motion data of the character is created based on the character model data using any one of keyframing and kinematics motion control methods.

9. The apparatus of claim 1, wherein the character model data includes at least one data of skeleton, skin mesh and rigging data of the character.

10. The apparatus of claim 1, wherein the dynamics motion data includes at least one data of input force, input torque, resulting location, resulting orientation, resulting linear velocity, resulting angular velocity and a collision-related event, with respect to each frame of dynamics bones.

11. A dynamics-based motion generation method, comprising:
converting character model data input to a computing device into dynamics model data of a character to be subjected to a dynamics simulation;
modifying the dynamics model data, and adding or modifying an environment model;
converting reference motion data of the character which has been created by using the character model data into dynamics motion data through the dynamics simulation by referring to the dynamics model data and the environment model;
editing the reference motion data to decrease a gap between reference motion data and dynamics motion data; and
controlling a robot by inputting preset torque values to related joint motors of the robot by referring to the dynamics motion data.

12. The method of claim 11, wherein said converting into dynamics motion data includes:
adding constraints regarding a location, velocity and acceleration of each bone to be corresponded with the motion data of the character; and
converting the dynamic model data into the dynamics motion data through the dynamics simulation which adds constraints satisfying a movement limitation range to dynamics joint data of the dynamics model data and which adds a constraint regarding maximum torque to dynamics bone data of the dynamics model data.

13. The method of claim 11, wherein the dynamics joint data includes at least one data of a location, a joint type, a movement limitation range, a maximum torque, and a list of connected dynamics bones.

14. The method of claim 11, wherein the dynamics bone data includes at least one data of a location, an orientation, a size, a mass, inertia, density, mesh, and a list of connected dynamics joint lists.

15. The method of claim 14, wherein:
the mass is set to a value obtained by multiplying a ratio of a size of the corresponding bone to a size of an entire character by a preset constant value;
the inertia is calculated from skin mesh and rigging data of the character model data; and
the mesh is processed as a box or cylinder shape.

16. The method of claim 11, wherein said modifying includes controlling an extent of conversion of the dynamics motion by controlling a maximum torque value of dynamics joint data of the dynamics model data.

17. The method of claim 11, wherein the modifying includes:
creating the environment model based on a motion environment of the character;
modifying at least one of a size, location and orientation of the created environment model.

18. The method of claim 11, wherein the motion data of the character is created based on the character model data by using any one of keyframing and kinematics motion control methods.

19. The method of claim 11, wherein the character model data includes at least one data of skeleton, skin mesh and rigging data of the character.

20. The method of claim 11, wherein the dynamics motion data includes at least one data of input force, input torque, resulting location, resulting orientation, resulting linear velocity, resulting angular velocity and a collision-related event with respect to each frame of dynamics bones.
